(19) United States
(12) Patent Application Publication
(10) Pub. No.: US 2014/0259143 A1
(43) Pub. Date: Sep. 11, 2014

(54) COMMUNICATION SYSTEM FOR A MOTOR VEHICLE

(71) Applicant: Jörg Kühnl, Weiherhammer (DE)

(72) Inventor: Jörg Kühnl, Weiherhammer (DE)

(73) Assignee: ZF Friedrichshafen AG, Friedrichshafen (DE)

(21) Appl. No.: 14/351,215

(22) PCT Filed: Sep. 13, 2012
(86) PCT No.: PCT/EP2012/067899

§ 371 Date: May 21, 2014

(30) Foreign Application Priority Data
Oct. 11, 2011 (DE) 10 2011 084 254.3

(51) Int. Cl. H04L 29/06

(52) U.S. Cl. CPC H04L 63/0218
USPC 726/11

(57) ABSTRACT

A communication system for a motor vehicle comprises a telemetry terminal with a plurality of interfaces, a motor vehicle control device terminal, a bus by means of which the telemetry terminal and the motor vehicle control device terminal are communicating with each other, and a firewall which monitors the communication between the telemetry terminal and the motor vehicle control device terminal.

The present invention relates to a communication system for a motor vehicle according to the preamble of Claim 1.

In motor vehicles, communications between electronic components, especially with the inclusion of control devices, becomes more and mort important. Besides purely intra-vehicle communication, inter-vehicle communication or communication with the surrounding area is coming to the fore. Data to be communicated can be transmitted to a telemetry unit, especially in the form of a telemetry box, which is linked for this purpose with information sources and sinks, i.e., in wireless fashion and/or by wire connection. For example, by means of such telemetry unit a fleet management can be implemented, for example for commercial vehicles or busses.

In such a communication system in which control unit data are retrieved from a telemetry terminal, especially by wire connection, it is not merely required to be able to read data from the control devices, for example maintenance and service management data, but in the context of specific applications. For example, if a vehicle is stolen, which results that the vehicle can only be switched to first gear, it is also required the telemetry box has write access to the control device. However, this involves a considerable risk with regard to functional safety, for example SIL_{>}=2 or ASIL_{>}=B. This risk has to be avoided with appropriate hardware and software adaptations in the telemetry box, especially in accordance with IEC 61508 or ISO 26262.

However, in elaborately designed telemetry boxes, especially those equipped with a plurality of interfaces which are, for example based on an Intel processor with a Linux operating system, it is extremely expensive to realize these security implementations.

Based on these facts, the present invention has the object of providing a communication system which overcomes these disadvantages and which can be realized in a cost-effective manner by providing the required functional safety.

According to the invention, the problem is solved by means of the characteristics of Claim 1. Advantageous embodiments and further developments are presented in the dependent claims.

The invention provides a communication system for a motor vehicle. The communication system comprises a telemetry terminal with a plurality of interfaces as well as a motor vehicle control device terminal. To this end, the communication system can be implemented as a distributed system, i.e., that the telemetry terminal and the motor vehicle control device terminal are independent computers which communicate with each other. It is generally preferred that the communication system is a component of the motor vehicle which can include, for example, a commercial vehicle, a passenger car, a bus or a different motor vehicle.

The telemetry terminal can be designed as a telemetry switchboard, such as a telemetry box, and can comprise, for example, interfaces for USB, Ethernet, video out, audio out, WLAN, 3G, such as UMTS, GSM, and can have diagnostic analysis and further interfaces depending on requirements, which allows for communication with the surrounding area via the telemetry terminal in addition to the intra vehicle communication. In the context of the present invention, provision is made to use the telemetry terminal for centralized information transfer or information processing of information relating to the motor vehicle and/or its components, in particular for transmission of such information to the surrounding area or external recipients.

To provide a comprehensive function set, it is preferred to design the telemetry terminal in computerized or processor-based fashion. For example, in a preferred embodiment, the telemetry terminal is based on an Intel atom processor with IO hubs and includes a Linux operating system.

Preferably, the motor vehicle control device terminal is formed by means of a motor vehicle control device, by means of a transmission control unit. Alternatively, the motor vehicle control device terminal can be formed by means of an engine control unit or a different control unit of the motor vehicle.

Furthermore, the communication system or motor vehicle communication system comprises a bus by means of which the terminals are communicating among each other or transmit information. Preferably, the bus is a CAN bus to which the terminals are linked via appropriate interfaces. Alternatively, it is possible to use different bus forms, for example a proprietary bus or a LIN bus.

To be able to implement the functional safety between the terminals in the required communication system or the data communication in a simple manner, in the invention the communication system has a firewall which monitors communication or information transmission between the terminals. Advantageously, it is therefore possible to refrain from using elaborate hardware and software solutions for implementing functional safety for the telemetry terminals. In this connection, the term “firewall” comprises software solutions in the sense of firewall software, as well as hardware-software solutions, for example independent firewall devices which are generally also described as “external firewall”.

Preferably, the firewall is integrated as bus firewall, in particular as CAN firewall, in the bus between the terminals, especially linked via a respective bus interface with the telemetry terminal and/or motor vehicle control device terminal. In particular, it is proposed to design the firewall as external firewall, preferably within an independent platform or by means of independent hardware or software. Preferably, the firewall is formed by means of a microcontroller and at least two bus interfaces for connecting to the telemetry terminal and the motor vehicle control device terminal. Alternatively, the firewall can be designed as an integral part of the telemetry terminal, i.e., according to a personal firewall or, for example, even merely as a software firewall.

In a preferred embodiment of the invention, it is provided that the operation of the firewall is monitored by means of a monitoring unit of the communication system, in particular a watchdog unit. In this way, functional safety can be further increased. The monitoring unit can be part of the firewall or can be designed as a separate component.

In particular, provision is made that the firewall monitors write accesses the telemetry terminal has on the motor vehicle control device terminal. In this way, it can be ensured that the telemetry terminal does not permit any write access on the motor vehicle control device terminal which endangers the functional safety of the motor vehicle control device terminal.

Preferably, the firewall control of communication and write access takes place by means of a white list, i.e., a list or chart of permitted commands and value ranges or rules the content of which the firewall can retrieve. For this purpose, the white list can be appropriately stored, for example in a memory. If the firewall receives a write access command from the telemetry terminal, it can examine by means of the white list whether the command is permitted and can be applied with a corresponding rule for communication. When permission is approved, the firewall can transmit the command to the motor vehicle control device terminal.

Furthermore, to increase security, it is provided that the firewall data packages sent to the motor vehicle control device terminal are analyzed, encoded or modified before passing on to the motor vehicle control device terminal. For this purpose, user data from the firewall can be supplemented, for example with a header, additional data, for example a time stamp, a security code and a transmission code. By means of data modified in such a way, further protective filtering functions can be implemented through the firewall in communication between the terminals, such as verification or authentication by means of a proof total.

In a further advantageous embodiment of the invention, it is provided that the firewall assumes error handling in the communication between the telemetry terminal and motor vehicle control device terminal within the communication system.

For example, the following types of error can be detected:
Repetition of the same messages,
Omission of unintended messages,
Insertion of unintended messages
Interchange of messages,
Distortion of messages
Delay of messages,
Manipulation of messages.

For this purpose, the firewall can have filtering functions designed in an application-specific fashion. As an additional element, for example, it is possible to integrate in the firewall IDS or IPS functions, i.e., Intrusion Detection System or Intrusion Prevention System functions.

Further characteristics and advantages of the invention can be derived from the subsequent description of embodiments of the invention, the figure of the drawing which shows invention-based details, and the claims. The particular characteristics can each be implemented on an individual basis as well as in any combination in a model of the invention.

Subsequently, preferred embodiments of the invention are described in more detail by means of the enclosed drawing. It is shown:

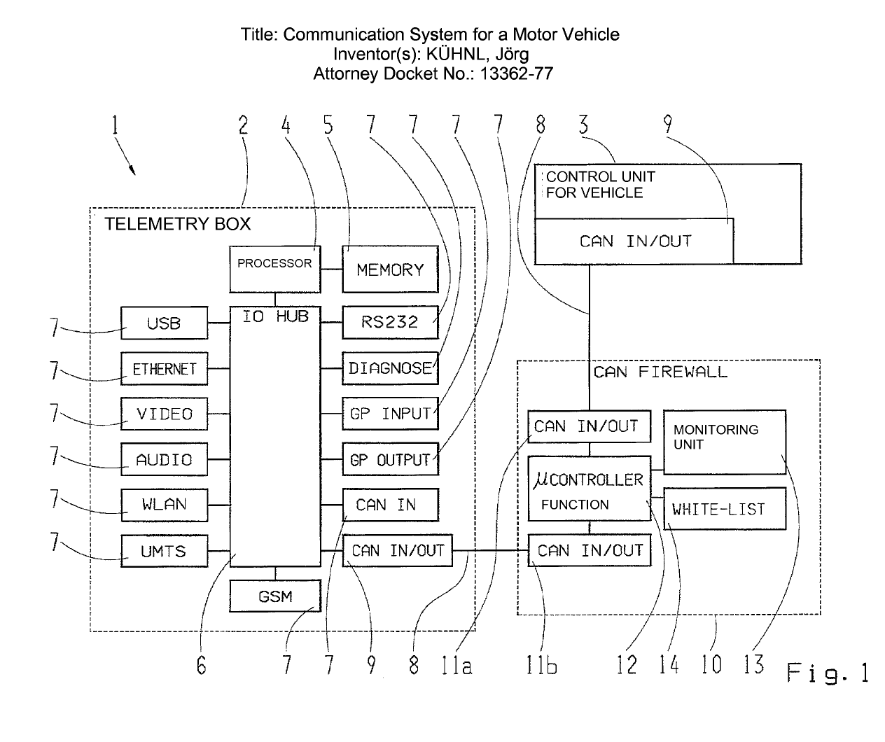

FIG. 1 A communication system illustrated in an exemplary and schematic manner according to an embodiment of the invention.

In the subsequent descriptions of the figure the same elements or functions are provided with the same reference numerals.

FIG. 1 shows a communication system 1 in an exemplary and schematic manner for a motor vehicle with a telemetry terminal 2, which is formed by a telemetry box, as well as a motor vehicle control device terminal 3 in the form of a control device, particularly a transmission control unit.

The telemetry box 2 is formed by means of an Intel atom processor 4 with a Linux operating system including a respective memory 5, as well as an IO hub 6, and comprises a plurality of interfaces 7, in particular a USB, Ethernet, video, audio, WLAN, UMTS, RS232, diagnosis, GP-Input, GP-Output, CAN-In and GSM interface.

By means of a plurality of interfaces 7, the telemetry terminal 2 can be supplied in a microprocessor-controlled manner with information, especially information of operational conditions of the motor vehicle and its components, for example, information supplied via or issued by the diagnosis and CAN-In interface, for example, information supplied via the UMTS and GSM interface, especially at least to a superior coordination unit, for example a fleet management control center. In this connection, it is also the object of the telemetry box or telemetry terminal 2 to read and analyze, or process, motor vehicle data or motor vehicle specific information, in particular data of the motor vehicle control device terminal 3.

Within the motor vehicle communication system 1, the telemetry box 2 and the motor vehicle control device 3 are communicating with each other via a CAN bus 8 of the vehicle, wherein the telemetry box 2 and the motor vehicle control device 3 each have a CAN interface 9 which supports bidirectional communication.

To monitor the communication between the telemetry box 2 and the control device terminal 3, a firewall 10 is integrated in the CAN bus 8 between the interfaces 9 of telemetry box 2 and control device terminal 3. The CAN firewall 10 comprises a first bidirectional CAN interface 11a and a second bidirectional CAN interface 11b, by means of which it is possible to implement a connection via the CAN bus 8 to the telemetry box 2 and the control device terminal 3. Consequently, all communication or data communication between telemetry box 2 and control device terminal 3 takes place via the firewall.

The firewall 10 is designed as an independent hardware platform, particularly an external firewall, wherein the firewall functions are implemented in software supported manner. Besides the CAN interfaces 11a described above, the completed firewall platform 10 comprises a microcontroller 12 which is monitored by a monitoring unit 13 in the form of a safety microcontroller with a watchdog unit. For implementing the firewall filtering function, the microcontroller 12 accesses a control stock return, which is stored in a memory or on a white list 14.

When the CAN firewall 10 receives a CAN write command from the telemetry box 2, the firewall 10 examines by means of the white list 14 whether the command is permitted. When permission is approved, write access to the motor vehicle control device terminal 3 can take place, the command is transmitted to the motor vehicle control device terminal 3.

Furthermore, checking mechanisms are implemented in the firewall 10, so as to be able to at least detect system interventions, such as an IDS and/or IPS function. For this purpose, communicated user data are supplemented by the firewall, in particular with a header, additional data, for example a time stamp, as well as a security code and transmission code. A proof total formed on the basis of the supplemented data now allows verification and/or authorization.

Within communication with the control device terminal 3, the CAN firewall 10 also assumes error handling. Here, an error comprises repetition of the same messages, omission of unintended messages, insertion of unintended messages, interchange of messages, distortion of messages, delay of messages and manipulation of messages.

It should be noted that the communication system 1 is not restricted to the two terminals 2, 3 described above. Within the present invention, provision can also be made to monitor the bus communication of several control device terminals 3 with the respective telemetry terminal 2 via the firewall 10 or a plurality of firewalls 10, in particular the write access of the telemetry terminal 2 to the control device terminal 3.

### REFERENCE NUMERALS

1 Communication system
2 Telemetry terminal
3 Motor vehicle control device terminal
4 Processor
5 Memory
6 IO hub
7 Interface 2
8 CAN bus
9 CAN interface
10 Firewall
11 a, b CAN Interface 9
12 Microcontroller 9
13 Monitoring unit 9
14 White list

1-10. (canceled)

11. A communication system for a motor vehicle, comprising:
a telemetry terminal;
a motor vehicle control device terminal in communication with the telemetry terminal via a bus; and
a firewall configured to monitor the communication between the telemetry terminal and the motor vehicle control device terminal.

12. The communication system according to claim 11, wherein the firewall is integrated in the bus, linking to the telemetry terminal via a first interface and linking to the motor vehicle control device terminal via a second interface.

13. The communication system according to claim 11, wherein the firewall is configured to monitor write accesses the telemetry terminal conducts on the motor vehicle control device terminal.

14. The communication system according to claim 11, wherein to monitor the communication between the telemetry terminal and the motor vehicle control device terminal, the firewall is configured to:
receive a write access command from the telemetry terminal;
retrieve a communication rule from a whitelist;
examine whether there is a communication rule that applies to the write access command;
determine whether the write access command is permitted based on the examination; and
transmit the write access command to the motor vehicle control device terminal when the write access command is permitted.

15. The communication system according to claim 14, wherein the communication rule in the whitelist comprises at least one of a permitted command, a value range, and a rule.

16. The communication system according to claim 11, wherein the firewall is further configured to supplement communicated user data with at least one of a header, additional data, a time stamp, a security code, and a transmission code prior to the user data being transmitted between the motor vehicle control device terminal and the telemetry terminal.

17. The communication system according to claim 11, wherein the firewall is configured to handle an error in the communication between the telemetry terminal and the motor vehicle control device terminal.

18. The communication system according to claim 17, wherein the error comprises at least one of repetition of a same message, omission of an unintended message, insertion of an unintended message, interchange of a message, distortion of a message, delay of a message, and manipulation of a message.

19. The communication system according to claim 11, wherein the firewall is an independent platform from the telemetry terminal and motor vehicle control device.

20. The communication system according to claim 19, wherein the independent platform includes a microcontroller.

21. The communication system according to claim 11, wherein the firewall further comprises a watchdog unit for monitoring operations of the firewall.

22. The communication system according to claim 11, wherein the firewall is an external firewall.

23. The communication system according to claim 11, wherein the firewall is an integral part of the telemetry terminal.

24. The communication system according to claim 11, wherein the bus comprises a CAN bus;
the telemetry terminal comprises a telemetry box; and
the motor vehicle control device terminal comprises a transmission control unit.

25. A method for monitoring communication between a telemetry terminal and a motor vehicle control device terminal, comprising:
providing:
a telemetry terminal;
a motor vehicle control device terminal in communication with the telemetry terminal via a bus; and
a firewall configured to monitor the communication between the telemetry terminal and the motor vehicle control device terminal;
receiving, by the firewall, a write access command from the telemetry terminal;
retrieving, by the firewall, a communication rule from a white list;
examining, by the firewall, whether there is a communication rule that applies to the write access command;
determining, by the firewall, whether the write access command is permitted based on the examination; and
transmitting, by the firewall, the write access command to the motor vehicle control device terminal when the write access command is permitted.

26. The method according to claim 25, wherein the firewall is integrated in the bus and wherein the firewall is linked to the telemetry terminal via a first interface and linked to the motor vehicle control device terminal via a second interface.

27. The method according to claim 25, wherein the communication rule in the white list comprises at least one of a permitted command, a value range, and a rule.

28. The method according to claim 25, further comprising:
handling, by the firewall, an error in the communication between the telemetry terminal and the motor vehicle control device terminal.

29. The method according to claim 28, wherein the error comprises at least one of repetition of a same message, omission of an unintended message, insertion of an unintended message, interchange of a message, distortion of a message, delay of a message, and manipulation of a message.

30. The method according to claim 25, further comprising providing a watchdog unit for monitoring operations of the firewall.
